(19) United States
(12) Patent Application Publication
(10) Pub. No.: US 2011/0285451 A1
(43) Pub. Date: Nov. 24, 2011

(54) PRECISION VOLTAGE DIVIDER

(75) Inventor: Robert Alan Neidorff, Bedford, NH (US)

(73) Assignee: TEXAS INSTRUMENTS INCORPORATED, Dallas, TX (US)

(21) Appl. No.: 12/784,303

(22) Filed: May 20, 2010

(51) Int. Cl. G06G 7/16

(52) U.S. Cl. 327/360

(57) ABSTRACT

A circuit for producing a quotient of two input voltages, Vy and Vx has a resistor across which said two input voltages are selectively successively applied. An operational amplifier has a reference potential (Vref) applied to one input, and a tap selectively connectable at one side to various points of the resistor is connected at its other side to the other input of the operational amplifier. The tap also provides a voltage output node of the circuit. After the tap has been configured with input voltage Vy applied across the resistor so that a voltage on the output node is substantially equal to the reference potential (Vref), when the input voltage Vx is applied across the resistor, a voltage on the output node represents a quotient of the input voltages Vy and Vx.

### BACKGROUND

1. Field

This invention relates broadly to improvements in electrical circuits and methods, and more particularly to improvements in precision voltage dividers and methods for producing a quotient between two input voltages.

2. Background

Circuit designers often have a need to use voltage dividers in their circuit designs. One example is in the design of power supply circuits that deliver constant power in their operation. Many constant power circuits, for example, have a feedback loop that adjusts the current in the power supply based upon changes in the input voltage. Thus, for instance, to maintain the power at a constant level if the input voltage drops, the input current needs to be boosted, and visa versa. One way that this may be accomplished is by developing a quotient between a reference voltage and the input voltage to the circuit to which power is being supplied and adjusting the current based upon the voltage quotient. Many other examples exist, as well.

Voltage divider circuits, however, are often required to be precise to provide a quotient value that is within tight tolerances, among other things, to maintain the constant power within concomitant tight tolerances. For example, LED displays require a constant power source which has very tight tolerances. The requirement for tight tolerances, in turn, has required the use of precision parts, which also needed to be within close tolerances. Often, for example, the voltage divider circuits in the past have required precise trimming of resistor and other elements used in the circuit. As a result, often the voltage divider circuits that were designed were relatively expensive and labor intensive to fabricate.

Moreover, in order to maintain the quotient produced by many voltage divider circuits, additional circuitry, such as sample and hold circuits were required. This further increased the cost and design complexity. Furthermore, many voltage divider circuits did not integrate well with digital processes, which are frequently used in many of today's technologies.

What is needed is a precision voltage divider circuit and method for producing a quotient between two input voltages in which circuit precision can be achieved with relaxed component accuracy and tolerance requirements, in which component trimming requirements are reduced or eliminated, and in which such can be designed for use in modern digital processes.

### SUMMARY

In accordance with broad aspects of the various voltage divider embodiments herein, a circuit is provided for producing a quotient of two input voltages, Vy and Vx. The circuit has a resistor connected between an input and a reference potential. An operational amplifier has a reference potential applied to one input, and a tap selectively connectable at one side to various points of the resistor. The tap is connected at another side to another input of the operational amplifier and to an output node. After the tap has been configured with input voltage Vy applied across the resistor so that a voltage on the output node is substantially equal to the reference potential, when the input voltage Vx is applied across the resistor, a voltage on the output node represents a quotient of the input voltages Vy and Vx. A control element is provided for controlling the tap and selectively applying the input voltage Vx and Vy across the resistor.

In accordance with other broad aspects of the various voltage divider embodiments herein, a circuit is provided for producing a quotient of two input voltages. The quotient producing circuit includes a circuit for establishing a voltage ratio of one of the input voltages, wherein the voltage ratio has a ratio portion substantially equal to a reference voltage. The quotient producing circuit also includes a circuit for applying the voltage ratio to another of the input voltages, wherein a ratio portion of the another of the input voltages is substantially equal to the reference potential times the quotient of the input voltages.

In accordance with yet other broad aspects of the various voltage divider embodiments herein a voltage divider is provided for dividing two voltages, Vy and Vx. The voltage divider includes an input switch for selecting one of Vy and Vx as an input voltage and a plurality of resistors connected in series between the input switch and a reference potential. An operational amplifier, having a reference potential applied to one input is provided along with a plurality of tap switches, each connected at one side to respective tap points between the resistors and at another side to another input of the operational amplifier and to an output node. A control element is also provided for operating the input switch to select the Vy voltage as an input voltage and selectively closing the plurality of switches until a voltage applied to the another input of the operational amplifier is substantially equal to the reference potential. The control element thereafter operates the input switch to select the Vx voltage for input with a same configuration of the plurality of switches selectively closed when the Vy was applied, whereby a voltage on the output node represents a quotient between the Vy voltage and the Vx voltage.

In accordance with still other broad aspects of the various voltage divider embodiments herein a method is provided for producing a voltage quotient between first and second input voltages. The method includes applying the first input voltage to a resistor connected to a first reference potential. Various tap points are selectively connected along the resistor to an input of an operational amplifier until an output of the operational amplifier reaches a predetermined voltage with respect to a second reference potential to define a connection configuration. Using the connection configuration, the second input voltage is applied across the resistor, wherein a voltage on the input to the operational amplifier represents, as a circuit output, the second reference potential times a quotient between the first and second voltages.

### BRIEF DESCRIPTION OF THE DRAWINGS

Various exemplary embodiments of the invention are described in detail in the accompanying drawing, in which:

FIG. 1 is an electrical schematic diagram of a basic embodiment of a precision voltage divider.

FIG. 2 is a flow diagram showing the operation of the voltage divider of FIG. 1.

FIG. 3 is an electrical schematic diagram of another embodiment of a precision voltage divider.

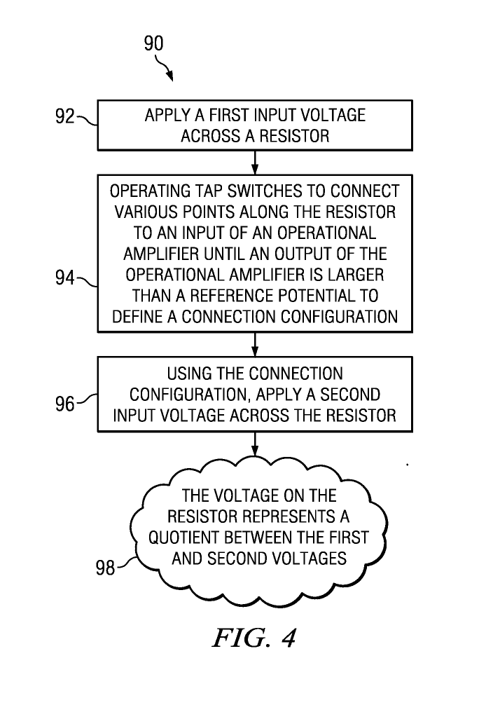

And FIG. 4 is a flow diagram showing the operation of the voltage divider of FIG. 3.

### DETAILED DESCRIPTION

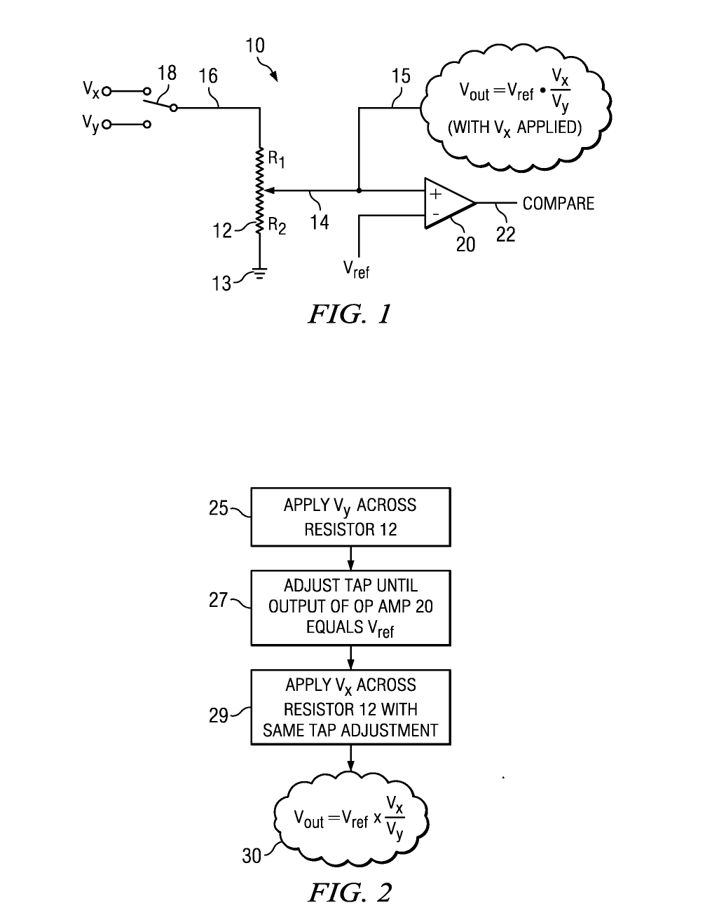

With reference first to FIG. 1, one embodiment of a voltage divider circuit 10 is broadly shown. The voltage divider circuit 10 produces an output that represents a quotient between two input voltages, Vx and Vy. The voltage divider circuit 10 has a resistor 12 connected between an input line 16 at one end and to a reference potential 13 at its other end. The resistor can be of any known construction. As will be discussed in greater detail below, the precision of the resistor 12 is not of great importance. The resistor 12 may be a discrete device, as shown, or it may be constructed of integrated circuit components, for example, on a silicon or other semiconductor substrate.

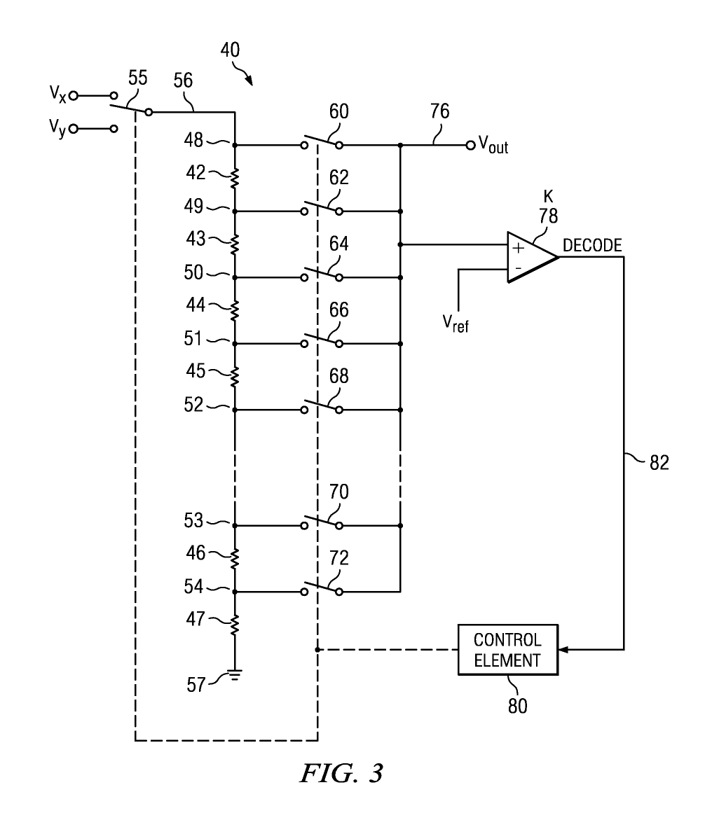

A tap 14 is adjustable to selectively adjust the ratio R1/R2 of the resistances above and below the tap 14. Thus, the tap 14 establishes a voltage ratio equal to the ratio R1/R2, and the voltage portion across the lower resistance R2 is applied to a non-inverting input of an operational amplifier 20. The tap 14 can be a single mechanical contact, as suggested in the FIG. 1 embodiment, or any other selector, such as a plurality MOSFET or other switching devices arranged along the length of the resistor 12 to select various resistance ratios R1/R2, as suggested in the embodiment below described with reference to FIG. 2. It should therefore be noted that the term “tap” is not intended to designate only a single connection to the resistor 12, but is intended to also encompass a plurality of connection points that can be selectively individually established. In addition, it should also be noted that the tap is not intended to refer only to a continuously moveable connection point, but is intended also to refer to discrete connection points for selective connection, as also described herein. The output of the voltage divider circuit 10 is developed at the tap 14 on output node or line 15.

The input line 16 is selectively connected by a switch 18 to receive either input voltage Vx or input voltage Vy, the quotient of which is to be developed by the voltage divider 10.

The tap 14 is connected to the non-inverting input of an operational amplifier 20 to apply the voltage developed on the bottom resistor segment R2 of the resistor 12 thereto. A reference potential, Vref, is applied to the inverting input of the operational amplifier 20. The voltage Vref may be of any appropriate voltage within the range of the input voltages Vx and Vy. Thus the resistor 12 and the tap 14 serve as a voltage divider to divide the input voltage across the resistor 12 according to the position of the tap 14.

With reference additionally now to FIG. 2, the operation of the voltage divider circuit 10 is illustrated. In operation, the switch 18 is operated to first apply the voltage Vy to the voltage divider circuit 10 to be developed across the resistor 12, box 25. The voltage Vy is divided by resistor portions R1 and R2, and the portion of the voltage Vy developed on resistor portion R2 is applied to the non-inverting input of the operational amplifier 20. The tap 14 is adjusted until the output on line 22 from the operational amplifier 20 equals Vref, box 27. (It should be noted that the term “equals” used herein in intended to mean “substantially equals,” and the degree of equality is dependent upon the resolution of the voltage divider circuit 10, which, as described below, can be constructed to achieve essentially any resolution, depending on the application, expense constraints, and so on. It should also be noted that the tolerances of the resistor 12 are not a factor in the output accuracy of the voltage divider circuit 10, since tolerance errors cancel in the division process, described below.)

With the tap 14 in the position selected where the output on line 22 from the operational amplifier 20 equals Vref, the switch 18 is switched to apply the voltage Vx to the input line 16. The voltage Vx is developed across the resistor 12 and divided according to the same resistance ratio, R1/R2, as that determined during the application of Vy, box 29. This, as mentioned, cancels any tolerance variations of resistor 12. The output on the output node or line 15 will therefore be Vref*Vx/Vy, cloud 30.

With reference additionally now to FIG. 3, another embodiment of a voltage divider 40 is shown. The voltage divider 40 establishes a quotient between two input voltages, Vx and Vy. The voltage divider 40 has a plurality of resistors 42-47 connected in series between an input line 56 and a reference potential 57. The resistors 42-47 may be of any convenient number, and can be discrete devices, resistor segments formed as a part of an integrated circuit, a continuously formed element with taps along its length, or other suitable structure. Also, depending on the context, the singular term “resistor” may be used herein to refer collectively to the series connected resistors 42-47. A switch 55 selectively connects either input voltage Vy or input voltage Vx across the resistors 42-47 between the input line 56 and the reference potential 57.

In the embodiment shown in FIG. 3, a plurality of switches 60-72 are connected at one of their sides to various respective tap points 48-54 along the length of the resistors 42-47. The switches 60-72 may be, for example, mechanical switches, logic devices, MOSFET or other semiconductor switching devices, or the like. The other sides of the switches 60-72 are connected to the output line 76 and to the non-inverting input of an operational amplifier 78.

Any number of resistor stages may be employed (for purposes hereof, a “stage” being a resistor/tap-point combination), depending upon the desired calculation resolution to be achieved. For instance, an example of a multi-stage data converter architecture that can be used to extend the output resolution is shown and described in U.S. Pat. No. 5,554,986, which is incorporated herein by reference in its entirety, assigned to the assignee hereof. Any number of stages can be used. Any number of resistors per stage can be used, and any binary or other scaling scheme is optional.

A reference voltage, Vref, is applied to the inverting input of the operational amplifier 78. The output of the operational amplifier 78 is connected to a control element 80. The control element 80 may be, for example, a part of a programmed microprocessor or microcontroller. The control element 80 is connected to operate the switches 60-72 and 55, and to receive the output from the operational amplifier 78 on line 82.

The control element 80 serves to provide automatic sensing of the output of the operational amplifier 80 to initialize the switches 60-72 as Vy is selected by switch 55 to apply input voltage Vy across the resistors 42-47. The control element 80 initializes the switches 60-72 by closing the individual switches until the output on line 76 equals the reference voltage, Vref. To sense the switch configuration at which the output from the operational amplifier 78 equals the reference voltage Vref, the operational amplifier 78 may be configured, for example, as a comparator that changes output state when the output voltage on line 76 just exceeds the reference voltage, Vref. Alternatively, the operational amplifier may be operated to produce a zero output when the voltage on the non-inverting input equals Vref. Other voltage sensing circuits or devices can be equally advantageously employed.

The operation of the switches 60-72 may be, for example, a simple sequential operation wherein first switch 60 is closed and a comparison of the voltage on output line 76 compared with the reference voltage, Vref. If the output voltage on line 76 does not exceed the reference voltage, Vref, switch 60 is opened, the next switch 62 is closed, and the voltage on output line 76 is again compared with the reference voltage, Vref. The process may be repeated until the voltage on output line 76 equals the reference voltage, Vref. At this point the ratio of the resistors above the established switch to the resistors below the established switch is maintained during the subsequent application of the input voltage Vx.

Alternatively, the switches 60-72 may be operated in accordance with other search protocols. An example of a different protocol is a binary search protocol in which a switch in the middle of the switches 60-72 may be closed. If the voltage at the tap point associated with the middle switch is equal to the reference voltage, Vref, the correct switch has been identified. If the voltage does not equal the reference voltage, Vref, the upper half or lower half above or below the middle switch is chosen for further searching, depending on whether the reference voltage is greater than or less than the voltage developed in the test of the middle switch tap point. Each additional search uses the same middle switch selection technique in the respective successive upper or lower-half selections. This search technique reduces the number of switches that need to be checked by a factor of two each time, and finds the sought reference voltage in logarithmic time. This protocol may be useful, for instance, if a large number of switch stages are used in a high resolution embodiment.

Once the selected voltage equals the reference voltage, Vref, the control element 80 maintains the configuration of the switches 60-72 and changes switch 55 to apply the input voltage Vx across the resistors 42-47. The switch configuration at which the voltage on output line 76 equals the reference voltage, Vref, is a digital representation of the input voltage Vy. Since the resistor divider established by the resistors 42-47 can be a one or many-stage divider, any number of bits can be generated.

One of the advantages realized by use of the voltage divider herein is, as mentioned above, the accuracy of the resistor divider is unimportant, since the same resistor ratio established during the measurement phase of input voltage Vy is used during the dividing stage when input voltage Vx is applied to the voltage divider circuit 40. As a result, the circuit is inexpensive, does not require resistor trim, is stable, and is well-suited to digital processes.

Furthermore, no sample and hold circuit is required unless it is desired that the output voltage, Vout, be a continuous signal. In that case, a simple sample and hold circuit can be used to hold the output voltage, Vout, during the times when the input voltage Vy is being converted.

With reference now additionally to FIG. 4, a flow chart is shown for illustrating an embodiment of a method for producing a voltage quotient between first and second input voltages, for example, utilizing the voltage divider circuit of FIG. 3. In accordance with this embodiment, as shown in box 92, a first input voltage is applied to a resistor, or a plurality of series-connected resistors, connected to a first reference potential, such as the reference potential 57.

Shown in box 94, a number of tap switches, such as the switches 60-72, are selectively connected to various points along the resistor, or resistors, and to an input of an operational amplifier, such as the operational amplifier 72. The switches are closed, according to a predetermined search protocol, until an output at which the operational amplifier equals a predetermined voltage with respect to a second reference potential, such as a reference voltage, Vref. This defines a connection configuration. As shown in box 96, using the connection configuration, the second input voltage is applied across the resistor, or resistors. Thus, as shown in cloud 98, the voltage on the output of the circuit represents the second reference voltage times a quotient between the first and second voltages.

Although the invention has been described and illustrated with a certain degree of particularity, it should be understood that the present disclosure has been made by way of example only, and that numerous changes in the combination and arrangement of parts may be resorted to without departing from the spirit and scope of the invention, as hereinafter claimed.

1. A circuit for producing a quotient of two input voltages, comprising:
a circuit for establishing a voltage ratio of one of said input voltages, wherein said voltage ratio has a ratio portion substantially equal to a reference voltage; and
a circuit for applying said voltage ratio to another of said input voltages, wherein a ratio portion of said another of said input voltages is substantially equal to said reference potential times the quotient of said input voltages.

2. The circuit of claim 1 wherein said circuit for establishing a voltage ratio is a voltage divider.

3. The circuit of claim 2 wherein said voltage divider comprises at least one resistor across which said input voltages are selectively applied and at least one tap on said at least one resistor, said tap being adjustable to establish said voltage ratio.

4. The circuit of claim 3 wherein said at least one tap is a plurality of switches to connect to respective tap points on said resistor.

5. The circuit of claim 4 wherein said plurality of switches is a plurality of MOSFET devices.

6. The circuit of claim 2 wherein said voltage divider comprises:
a plurality of resistors connected in series;
a plurality of tap switches each connected at one side to a respective tap point between said resistors and at another side to another input of said operational amplifier and to an output node, said tap switches being selectively closable to select one of said tap points to establish said voltage ratio on said plurality of resistors on respective sides of said selected tap point.

7. The voltage divider of claim 6 wherein said input and tap switches are semiconductor devices.

8. The voltage divider of claim 7 wherein said semiconductor devices are MOSFET devices.

9. The voltage divider of claim 6 wherein the tap switches are operated sequentially wherein only one tap switch is closed at a time.

10. The voltage divider of claim 6 wherein the tap switches are operated in accordance with a binary search protocol.

11. The voltage divider of claim 1 wherein said a circuit for establishing a voltage ratio of one of said input voltages comprises a comparator for comparing a reference voltage to said ratio portion.

12. A voltage divider for dividing two voltages, Vy and Vx, comprising:
a plurality of resistors connected in series;
an input switch for selectively applying one of Vy and Vx as across said plurality of resistors;
an operational amplifier, having a reference voltage applied to one input;
a plurality of tap switches each connected at one side to a respective tap point between said resistors and at another side to another input of said operational amplifier and to an output node; and
a control element for operating said input switch to apply said Vy voltage across said plurality of resistors and selectively closing respective ones of said plurality of switches until a switch configuration is found in which a voltage applied to said another input of said operational amplifier is substantially equal to said reference voltage,
said control element thereafter for operating said input switch to apply said Vx voltage across said plurality of resistors with said plurality of tap switches in said found configuration, whereby a voltage on said output node represents a quotient between said Vy voltage and said Vx voltage, times said reference voltage.

13. The voltage divider of claim 12 wherein said input and tap switches are semiconductor devices.

14. The voltage divider of claim 12 wherein said semiconductor devices are MOSFET devices.

15. The voltage divider of claim 12 wherein the tap switches are operated sequentially wherein only one tap switch is closed at a time.

16. The voltage divider of claim 12 wherein the tap switches are operated in accordance with a binary search protocol.

17. The voltage divider of claim 12 wherein said operational amplifier is configured as a comparator with said reference potential applied to an inverting input and with said another input being a non-inverting input.

18. A method for producing a voltage quotient between first and second input voltages, comprising:
applying said first input voltage across a resistor;
selectively connecting various tap points along said resistor to an input of an operational amplifier until an output of said operational amplifier reaches a predetermined voltage with respect to a reference voltage to define a connection configuration; and
using the connection configuration, applying said second input voltage across said resistor, wherein a voltage on said input to said operational amplifier represents, as a circuit output, the reference voltage times a quotient between said first and second voltages.

19. The method of claim 18 wherein said connecting comprises selectively operating tap switches respectively connected to said various tap points along said resistor.

20. The voltage divider of claim 19 wherein said selectively operating tap switches comprises operating said tap switches in accordance with a binary search protocol.
